(19) United States
(12) Patent Application Publication
(10) Pub. No.: US 2004/0263289 A1
(43) Pub. Date: Dec. 30, 2004

(54) Resonator structures

(76) Inventor: Gary R Cobb, Portsmouth (GB)

Correspondence Address: NIXON & VANDERHYE, PC, 1100 N GLEBE ROAD, 8TH FLOOR, ARLINGTON, VA, 22201-4714, US

(21) Appl. No.: 10/494,611

(22) PCT Filed: Mar. 30, 2004
(86) PCT No.: PCT/GB04/01345

(30) Foreign Application Priority Data
Mar. 31, 2003 (GB) 0307410.1
Mar. 31, 2003 (EP) 03252031.4

(51) Int. Cl. H01P 7/06

(52) U.S. Cl. 333/231

(57) ABSTRACT

A split-thread tuning screw element 1′ with a common pitch characteristic is provided which relies upon controllable expansive movement of the pitch characteristic for enhanced tuning performance. The inventive element 1′ bears definite advantage over known tuning arrangements, and it retains utility for many tuning applications, for example applications in various electrical circuits, resonator structures and microwave filters.

### FIELD OF THE INVENTION

This invention concerns improvements relating to resonator structures and more particularly, though not exclusively, concerns improvements relating to the tuning mechanism used in the adjustment of radio frequency resonators that form the important parts of microwave filters and/or resonator controlled microwave oscillator systems. In particular, the inventive improvements are directed to threaded tuning screw mechanisms most often used in influencing the resonant frequency of transmission line resonators typified by, but not limited to, coaxial, helical and balanced waveguiding structures in allowing for mechanical dimension variation inevitably generated during the production manufacture of microwave filters and/or resonator controlled oscillator systems.

Further, this invention is related to the use of tuning systems in resonators that are deliberately designed to be smaller than the principal mode of resonance using, for example, capacitive loading. This may be the case in the pursuit of size reduction or the incorporation of a tuning characteristic that defeats the changing resonant frequency with environmental conditions such as temperature or humidity.

### BACKGROUND OF THE INVENTION

In electrical circuits which operate beyond the range of frequencies where lumped element reactive components are predictable or reliable, it is often necessary to utilise the properties of transmission lines, in either travelling or standing wave configurations, substituting for the desired effects of ideal lumped element reactive components. As is known in the art, there are various advantages in using transmission line elements as both operating frequency and power level increase.

To allow for achieved dimensional tolerance in resonators constructed of either lumped elements or transmission lines, variable elements or tuning devices may deliberately be incorporated so as to be able to recover the designed resonant frequency in a controlled way. For lumped element networks, the variable component may be one of numerous known designs of tuning capacitor or permeability tuned inductor. For transmission line networks, it is typically convenient to utilise metallic, dielectric, or magnetic obstacles that can perturb the electric or magnetic component associated with the electro-magnetic travelling or standing wave. Typically, the degree of penetration of the obstacle into the resonator interior controls the perturbation of the corresponding electric or magnetic field within the resonator and so changes the resonant frequency in some proportion. The relationship between obstacle penetration and obtained resonant frequency depends upon the detailed position within the resonator and is usually, but not necessarily, non-linear. These obstacles are usually associated with a screw thread engagement system as a means of causing a longitudinal adjustment by physical rotation.

For all these known tuning schemes, the variable device, apart from producing the desired effect, can also introduce undesired properties so as to limit, in some way, the performance of the circuit. In particular, for resonators, tuning elements can introduce a real resistive (Ohmic) component that can cause an increase in the dissipated power characteristic quantified by that known in the art as unloaded quality factor (Qu). For both highly selective and high power filter circuits it is desirable to achieve the highest available quality factor (Qu) so as to provide the lowest possible dissipation within the physical structure. Induced loss from tuning devices should therefore be reduced/minimised to achieve the highest performance offered by the chosen circuit configuration.

For tuning obstacles conventionally utilising a screw thread as a means of adjustment, known previously as a tuning screw, there is necessarily a means of disallowing further adjustment after the tuning process has been completed, known previously as a locking mechanism. The simplest tuning screw may be a metallic rod, possessing an external thread feature, passing through the metallic boundary wall of the resonator to be tuned with a female thread cut therein possessing a corresponding pitch, diameter and form with sufficient clearance so as to allow mechanical rotation and therefore longitudinal movement of the metallic rod. The simplest locking mechanism may be a nut having a female thread corresponding in pitch, diameter and form to that of the tuning screw male thread. By means of preventing further tuning screw rotation during the locking process, the nut can be tightened against the boundary wall of the resonator causing an interference between the tuning screw male thread and the female thread in the resonator boundary wall. The means of preventing further tuning screw rotation during the locking process may be typified by a transverse feature on the external end of the tuning screw previously known as a screwdriver slot.

In operation, the unlocked tuning screw is mechanically rotated using the external screwdriver slot in order to achieve the required internal penetration and consequential resonance frequency of the resonator being tuned. At this stage, the locking nut is usually tightened using just sufficient torque so that the tuning screw has increased mechanical resistance to rotation in an attempt to take up the available clearance between the tuning screw male thread and the resonator wall female thread. As this action causes a small longitudinal movement of the tuning screw overall penetration, the resonance frequency of the resonator is subject to a small unintentional change to that previously set. It is consequently necessary to correct this small change in resonance frequency by applying additional rotational force, sufficient to overcome the tightening torque of the locking nut, so as to re-establish the proper tuning screw penetration. After achieving this correction, the locking nut may again be tightened to beyond the previously set torque and the frequency correction process described repeated until the correct resonance frequency has been achieved simultaneously with a defined minimum locking torque for the nut. It is usually necessary to repeat this correction process many times to provide a satisfactory setting. A common modification to the locking process is to back-off the tuning screw before applying the final torque to allow for thread stretch particularly if the screw is long and thin.

On using the above described known tuning/locking procedure, a number of problems and deficiencies become apparent.

(1) Due to the increasing torque applied by the locking nut system, the tuning characteristic, beyond a certain lock nut torque, becomes somewhat elastic in nature making the locking process difficult to complete.

(2) At high locking torques, cold welding can occur if the tuning screw and resonator boundary wall are made of the same material.

(3) At high locking torques, thread form damage can occur on both of the male and female engagement threads causing thread seizure.

(4) The induced resistive loss mechanism, associated with the thread engagement, varies as the locking nut torque increases.

The elastic nature of the known tuning screw/nut locking system, as in (1), depends on the material choice made for the tuning screw itself, the resonator structural boundary wall and the locking nut. Additionally, the aspect ratio of the threaded portion of the engagement, in respect of the materials chosen, is also important. For applications that need to operate in a non-terrestrial environment, outer space for example, the least massive of materials are preferred. These materials tend to have the lowest tensile strength, surface hardness and electrical conductivity of the available range of materials. It is commonplace to incorporate a low mass material for the resonator structural boundary and a more massive, harder material for the relatively small tuning screw device. The shortest thread engagement, consistent with the materials chosen, is also commonplace.

The cold welding problem, as in (2), is exacerbated by the desired use of highly conductive metal plating. Silver (Ag) plating could be used, for example, to minimise the induced resistive loss which would otherwise cause the ultimate Qu of the resonators electrical characteristic not to be realised. However, another problem occurs by forced rotation of the thread engagement at, or near to, the final locking nut torque necessary to complete the locking process. At this point, high frictional forces are present on the contacting faces of the thread form. It is often necessary to use a less conductive metal plating, Gold (Au) for example, for the tuning screw surface in an attempt to minimise this problem.

Thread damage can occur, as in (3), when the male and female form of the thread do not match. Under such conditions, the peaks of the thread form can be preferentially deflected from their nominal position which may cause breakage of the highly conductive metal plating in these areas and fracturing of the form itself leading to particulate generation and possible thread seizure when the tuning screw is subsequently rotated. Similarly, if the thread face surface finishes differ male to female, plating detachment can occur leading to unwanted particulate generation and possible thread seizure during subsequent tuning screw rotation.

It is commonplace to find that the resonator Qu parameter varies, as in (4), determined by the induced electrical contact resistance from the tuning screw, as the locking procedure is exercised. It is further observed that as tuning screw locking proceeds, the ultimate Qu performance for the resonator often falls as the potential deficiencies (2) & (3) build up. This can often be a diagnostic in terms of deciding when the tuning process is satisfactorily achieved with an adequate mechanical margin of safety. It is, however, recognised by the inventors that the ultimate Qu performance for the resonator is fundamentally limited, using the known tuning screw mechanism described, because the tuning screw male thread is pulled back onto the female thread of the resonator boundary wall way from the interior of the resonator. Thus, the electrical contact resistance between the male and female thread will be smallest where the pressure is highest which is closest to the locking nut toward the outside of the resonator structure and not as close to the resonator interior as possible where it is required.

### OBJECTS AND SUMMARY OF THE INVENTION

The present invention aims to overcome or at least substantially reduce some of the above-mentioned drawbacks.

It is the principal object of the present invention to provide an expansive and lockable tuning screw element which is cheap to produce and reliable for tuning applications in various kinds of electrical circuit.

It is another principal object of the present invention to provide an expansive and lockable split-thread screw design with enhanced tuning capability, this being made possible by virtue of the thread engagement becoming integrally part of the circuit to be tuned.

In broad terms, the present invention resides in the concept of providing a split-thread screw design with a common pitch characteristic which, in operation, can exhibit an enhanced tuning performance by virtue of controllably changing the common pitch characteristic in an expansive manner.

According to the present invention there is provided a lockable expansive tuning element comprising: a threaded body having a bearing surface of predetermined shape and size for bearing on a corresponding surface; an internally threaded locking screw portion housed within the threaded body; said threaded body being configured to carry a number of transverse cut portions in relation to a predefined longitudinal axis so as to provide a spacing between two or more groups of threads with a common pitch characteristic such that, in use, the tuning of the element is provided by controllably changing the common pitch characteristic in an expansive manner in dependence upon the amount of opening of the transverse cut portions.

In accordance with an exemplary embodiment of the invention which will be described hereinafter in detail, there are two transverse cut portions arranged to cross the threaded body diameter of the inventive element from opposing sides. It is to be appreciated, however, that the performance of the tuning element could possibly be improved, if desired, by provision of additional transverse cut portions on the element.

The tuning element of the invention conveniently includes rotational means for rotatably adjusting the longitudinal position of the locking screw portion when in use. For example, the rotational means is provided in a preferred embodiment by the formation of a number of hexagonally disposed flat faces machined onto the threaded body diameter of the element.

The tuning element in the abovementioned embodiment conveniently includes tuning correction means for establishing a predetermined amount of screw penetration associated with the screw engagement procedure.

As described more fully hereinafter, the tuning element of the invention has utility for many tuning applications in microwave filter systems, resonator-controlled oscillating systems and the like.

It is to be appreciated that the present invention extends to the method of controllably tuning an electrical circuit/system utilising the above described tuning element.

Further, the present invention extends to the method of operating the above described tuning element.

The above and further features of the invention are set forth with particularity in the appended claims and will be described hereinafter with reference to the accompanying drawing.

### BRIEF DESCRIPTION OF THE DRAWING

FIG. 1 is a cross-sectional view of a tuning element embodying the present invention.

### DETAILED DESCRIPTION OF AN EXEMPLARY EMBODIMENT

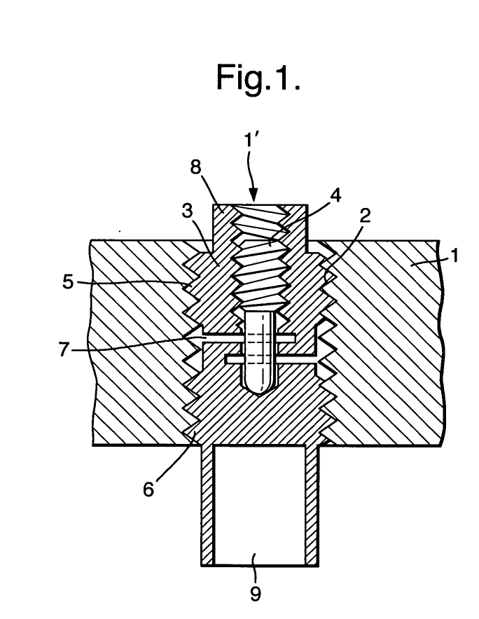

Referring to FIG. 1, there is shown in cross-sectional view a preferred lockable expansive tuning element 1′ embodying the present invention for use with a resonator structure. In this embodiment, it is noted that the tuning element 1′ is used for the adjustment of a metallic cylindrical obstacle 9. However, if desired, the arrangement could alternatively be such that the tuning element 1′ is used to adjust dielectric or magnetic obstacles, these being so shaped and sized as to be a constructional part of a similar screw thread that is exposed to the interior of the resonator structure in question.

More particularly, FIG. 1 shows the cross section of a typical resonator boundary wall 1 in which a female thread form 2 is cut and through which passes, in whole or part, a tuning screw possessing the matching male thread form. Further, the Figure shows the cross section of the proposed inventive split thread lockable tuning screw 3 with its internal threaded locking screw 4 in position. The split thread feature of the tuning screw 1′ is such that a plain section, with diameter less than the thread core, has a plurality of transverse cuts 7 crossing the thread body diameter from opposite sides and thereby separating two groups of threads 5,6 with a common pitch characteristic. Under normal working conditions, this creates a common engagement with the continuous female thread of the resonator boundary wall 2 allowing rotation, by external means, of the tuning screw so as to provide longitudinal adjustment in the conventional manner. Operation of the threaded locking screw 4 allows the opening of the transverse cuts 7 so as to change the common pitch shared by the two groups of threads 5,6 in an expansive way. Preferably, the external rotational means is provided by the formation of hexagonally disposed flat faces 8 machined, or otherwise manufactured, onto the thread diameter external to the split thread feature. This feature conveniently provides rotational adjustment of the tuning screw by conventional tooling, for example a spanner, whilst further allowing access to the threaded locking screw 4 using one of many known kinds of screw driver means.

Thus, in operation of the tuning element 1′ of the invention, the threaded locking screw 4 is in loose condition so that the pitch position of the two groups of threads 5,6 is common and easy rotation is achieved. The tuning proceeds, as previously described, whereupon the tuning screw 3 is mechanically rotated, typically using a spanner tool engaged with feature 8, in order to achieve the required internal penetration and permit the consequential resonance frequency of the resonator being tuned. In this condition, the locking screw 4 is tightened by using just sufficient torque so that the tuning screw 3 has increased mechanical resistance to rotational movement against the female thread 2 caused by expanding the distance between the two groups of threads 5,6 so as to misalign, to some small extent, the male thread group pitches. This action, as before, causes a small longitudinal movement in respect of the tuning screw's overall penetration of the resonator interior so that the resonance frequency of the resonator is subject to a small unintentional change to that previously set.

It is noted here that for the same physical clearance and thread class of the tuning screw engagement, as described previously for conventional tuning screws, there is approximately half the small change of obstacle penetration into the resonator interior previously described. This is due to the fact that the two thread groups 5,6 move respectively toward and away from the resonator interior by approximately equal amounts.

It is consequently, and as before, necessary to correct the small unintentional change in resonance frequency by applying additional rotational force, sufficient to overcome the initial tightening torque, caused by the misaligned male thread group pitches, so as to re-establish the proper tuning screw penetration. After achieving this correction, the threaded locking screw may again be tightened to beyond the initial tightening torque but unlike the tuning screw locking nut system described previously, very little, if any, returning is subsequently required.

It is also found that the known problem of resonator Qu parameter degradation, observed as tuning proceeds in conventional tuning screw and nut locking mechanisms, is effectively overcome using the proposed inventive split-thread lockable tuning screw 1′. Also, by using the inventive screw 1′, the ultimate resonator Qu obtainable is found to be significantly improved, as compared to previously disclosed tuning mechanisms.

The tuning element 1′ of the invention bears definite advantage over known tuning screw and nut locking mechanisms insofar as improved tuning operation and performance are concerned. This is readily apparent in a number of distinct ways.

(a) The problems associated with the elastic nature of conventional tuning screw and locking nut mechanisms are overcome in the invention because the highest thread engagement pressure is applied to the outer most parts of the two thread groups 5,6. Thus, the amount of physical movement available, for the obstacle penetrating the resonator interior, is severely limited.

(b) The cold welding problem does not arise in the invention because there is little, if any, rotational friction force applied to the tuning screw engaged thread faces as the internal threaded locking screw 4 is tightened, causing only longitudinal expansion.

(c) Thread damage is still possible when the male and female thread forms do not precisely match; however, the particulate caused by breakage of the highly conductive metal plating, by preferential thread peak deflection, cannot cause thread seizure in the inventive element due to the lack of subsequent tuning screw rotation. Similarly, if the thread face surface finishes differ male to female, plating detachment and thread seizure are unlikely to occur due to the lack of subsequent tuning screw rotation.

(d) The electrical contact resistance between the male and female thread will be smallest where the pressure is highest and is, for the invention disclosed, immediately adjacent to the interior of the resonator where it is required. This conveniently provides for the least reduction in the ultimate resonator Qu together with the smallest possible change of performance as the locking procedure is exercised.

Having thus described the present invention by reference to a preferred embodiment, it is to be appreciated that the embodiment is in all respects exemplary and that modifications and variations are possible without departure from the spirit and scope of the invention. For example, the tuning performance of the embodiment could possibly be improved, if desired, by provision of three, four or more transverse cut portions on the thread body of the inventive element. In this way, the inventive arrangement could be such that there are three, four or more split-thread groups with a common pitch characteristic.

It is to be appreciated that the tuning element of the invention retains utility for many applications, for example tuning applications in various microwave filters and resonator structures.

1. A lockable expansive tuning element comprising:
a threaded body having a bearing surface of predetermined shape and size for bearing on a corresponding surface;
an internally threaded locking screw portion housed within the threaded body;
said threaded body being configured to carry a number of transverse cut portions in relation to a predefined longitudinal axis so as to provide a spacing between two or more groups of threads with a common pitch characteristic such that, in use, the tuning capability of the element is provided by controllably changing the common pitch characteristic in an expansive manner in dependence upon the amount of opening of the transverse cut portions.

2. A lockable expansive tuning element as claimed in claim 1 wherein there are two transverse cut portions arranged to cross the threaded body diameter from opposing sides.

3. A lockable expansive tuning element as claimed in claim 1 including rotational means for rotatably adjusting the longitudinal position of the locking screw portion when in use.

4. A lockable expansive tuning element as claimed in claim 3 wherein said rotational means includes a number of hexagonally disposed flat faces machined onto the threaded body diameter.

5. A lockable expansive tuning element as claimed in any claim 1 including tuning correction means for establishing a predetermined amount of screw penetration associated with the screw engagement procedure.

6. (canceled)

7. A microwave filter system incorporating a lockable expansive tuning element as claimed in claim 1.

8. A resonator-controlled oscillating system or resonator structure incorporating a lockable expansive tuning element as claimed in claim 1.

9. A method of controllably tuning an electrical circuit/system utilising a lockable expansive element as claimed in claim 1.

10. (canceled)
